(19) United States
(12) Patent Application Publication
(10) Pub. No.: US 2021/0056855 A1
(43) Pub. Date: Feb. 25, 2021

(54) METHOD AND SYSTEM FOR PROCESSING MILITARY TRAINING ROUTES

(71) Applicant: ForeFlight LLC, Houston, TX (US)

(72) Inventors: Linnea Goss, Austin, TX (US); Travis Scott Clayton Root, Austin, TX (US)

(21) Appl. No.: 16/550,142

(22) Filed: Aug. 23, 2019

(51) Int. Cl. G08G 5/00; G08G 5/04; G06F 16/29; G06F 16/21

(52) U.S. Cl. CPC G08G 5/0034; G06F 16/212; G06F 16/29; G08G 5/04

(57) ABSTRACT

Processing military training routes (MTRs) includes obtaining an MTR database. The MTR database includes, for a multitude of MTRs, points for each of the multitude of MTRs, and links between the points. The processing of the MTRs further includes obtaining a user input including a selection of an MTR of the multitude of MTRs, recursively processing the selected MTR by following the links between the points associated with the selected MTR until a sequence of consecutive points between an entry point and an exit point is found, and visualizing the selected MTR.

### BACKGROUND

Military Training Routes (MTRs) are part of the airspace system. Particular risks are associated with MTRs. For example, MTRs allow aircraft to fly in excess of 250 knots in close proximity to the surface where new man-made obstacles may appear. Periodically updated databases that specify MTRs are available. A flight crew may want to use information obtained from these databases to conduct flights using MTRs.

### SUMMARY

In general, in one aspect, one or more embodiments relate to a method for processing military training routes (MTRs), the method comprising: obtaining an MTR database comprising, for a plurality of MTRs: a plurality of points for each of the plurality of MTRs, and a plurality of links between the plurality of points; obtaining a user input comprising a selection of an MTR of the plurality of MTRs; recursively processing the selected MTR by following the plurality of links between the plurality of points associated with the selected MTR until a sequence of consecutive points of the plurality of points between an entry point and an exit point is found; and visualizing the selected MTR.

In general, in one aspect, one or more embodiments relate to a system for processing military training routes (MTRs), the system comprising: a computer processor; and instructions executing on the first computer processor, causing the system to: obtain an MTR database comprising, for a plurality of MTRs: a plurality of points for each of the plurality of MTRs, and a plurality of links between the plurality of points; obtain a user input comprising a selection of an MTR of the plurality of MTRs; recursively process the selected MTR by following the plurality of links between the plurality of points associated with the selected MTR until a sequence of consecutive points of the plurality of points between an entry point and an exit point is found; and visualize the selected MTR.

In general, in one aspect, one or more embodiments relate to a non-transitory computer readable medium including computer readable program code for causing a computer system to obtain an MTR database comprising, for a plurality of MTRs: a plurality of points for each of the plurality of MTRs, and a plurality of links between the plurality of points; obtain a user input comprising a selection of an MTR of the plurality of MTRs; recursively process the selected MTR by following the plurality of links between the plurality of points associated with the selected MTR until a sequence of consecutive points of the plurality of points between an entry point and an exit point is found; and visualize the selected MTR.

Other aspects of the disclosed invention will be apparent from the following description and the appended claims.

### BRIEF DESCRIPTION OF DRAWINGS

FIG. 1 shows a block diagram of a system for processing military training routes (MTRs), in accordance with one or more embodiments of the disclosure.

FIGS. 2, 3, and 4 show flowcharts describing methods for MTRs, in accordance with one or more embodiments of the disclosure.

FIG. 5A shows an example of a recursive processing of an MTR, in accordance with one or more embodiments.

FIGS. 5B, 5C, 5D, and 5E show visualizations of MTRs, after the recursive processing of the MTRs, in accordance with one or more embodiments.

FIGS. 6A and 6B show computing systems in accordance with one or more embodiments of the disclosure.

### DETAILED DESCRIPTION

Specific embodiments of the disclosed technology will now be described in detail with reference to the accompanying figures. Like elements in the various figures may be denoted by like reference numerals and/or like names for consistency.

The following detailed description is merely exemplary in nature, and is not intended to limit the disclosed technology or the application and uses of the disclosed technology. Furthermore, there is no intention to be bound by any expressed or implied theory presented in the preceding technical field, background, brief summary or the following detailed description.

In the following detailed description of embodiments of the disclosed technology, numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Various embodiments of the disclosure enable the processing of military training routes (MTRs) to quickly and easily determine desired and correct routing of a Military Training Route (MTR). In the United States, MTRs are a part of the national airspace system, maintained by various military units and compiled and distributed by the National Geospatial-Intelligence Agency (NGA). MTRs are routes where the Federal Aviation Administration (FAA) and the Department of Defense (DoD) jointly have approved aircraft to fly in excess of 250 knots under 10,000 feet above sea level. MTRs are published on FAA Visual Flight Rules (VFR) and Instrument Flight Rules (IFR) sectional charts (shown as lines representing MTR corridors)) and published in a DoD Flight Information Publication (FLIP) in a document known as General Planning AP1B, and as comma-delineated alphanumeric data within DoD Digital Aeronautical Flight Information Files (DAFIF).

An MTR is a government specified path through an airspace and is often represented as a line on a map. The path and a tolerance around the path form a corridor. In other words, tolerances exist that allow for unintentional deviation from the MTR. Thus, a corridor includes the MTR and the specified volume of tolerance around the MTR.

The DAFIF includes a comprehensive database of up-to-date aeronautical data including information on airports, airways, airspaces, navigation data and other facts relevant to flying, managed by the NGA. The DAFIF may be periodically updated, e.g., every 28 days. In one or more embodiments, data extracted from the DAFIF is used to enable the planning of flights that involve MTRs and to visualize the MTRs. Methods in accordance with one or more embodiments may be used on mission planning systems, flight computers and/or aircraft navigation systems prior to and/or during the execution of a flight.

Embodiments of the disclosure, as subsequently described, provide quick and simple ways to navigate MTRs. An integration into a flight planning application may be used to deliver navigation guidance, fuel planning, etc. through uniquely complex branching pathways in 3-dimensional space, established by the MTRs and surrounding other airspace. Due to the complexity of MTRs, and because of hazardous circumstances associated with MTRs (such as, for example, new manmade vertical obstructions that may be added at any time), users of MTRs are obligated to update and maintain knowledge and charting of MTRs and the obstructions affecting the MTRs. Embodiments of the disclosure make it easier to users of the MTRs to familiarize themselves with the MTRs and obstructions by automating obstruction updates. For example, embodiments of the disclosure enable a visual rendering of a corridor established by an MTR, including directional arrows, indicators for entry and exit points, terrain features, obstructions, etc. These and other features are subsequently described.

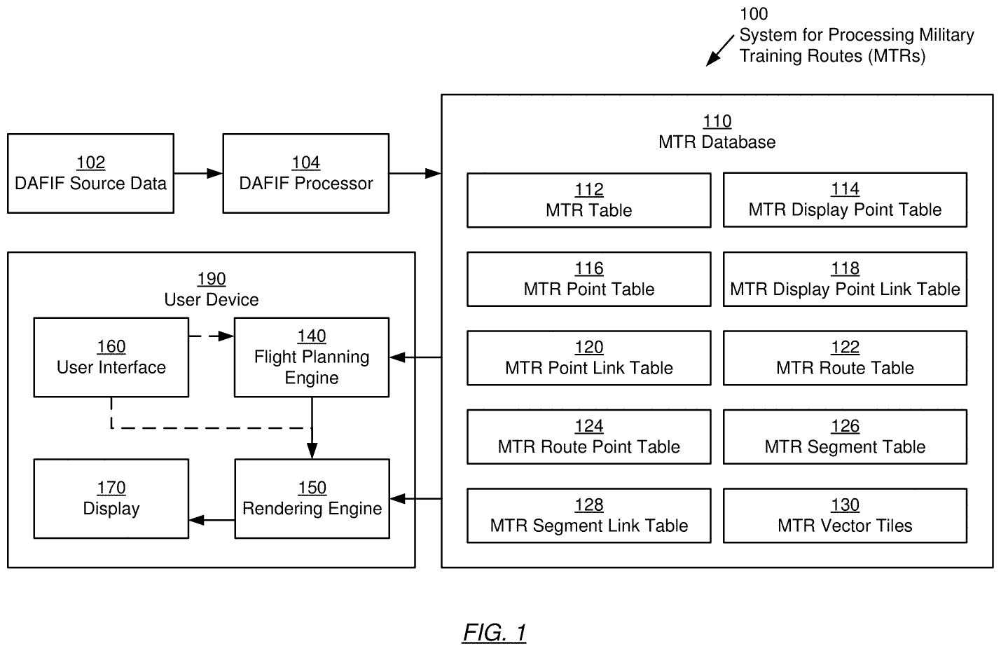

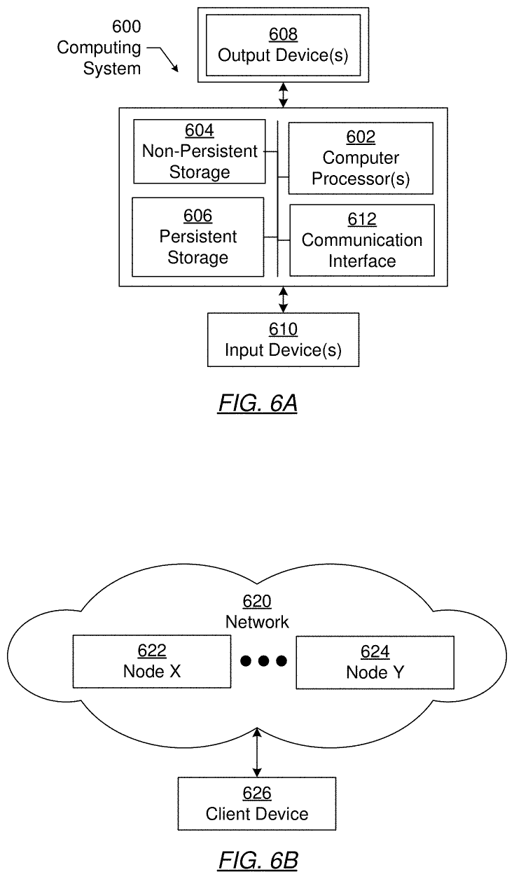

Turning to FIG. 1, a block diagram of a system for processing military training routes (MTRs), in accordance with one or more embodiments, is shown. The system (100) may be distributed and may include multiple computing systems and databases. As further described below, an MTR database (110) may be established from DAFIF source data (102). The DAFIF source data (102) may be obtained from a database that is administrated by the NGA. Alternatively, other data sources managed by other agencies may be relied upon, without departing from the disclosure. The content in the MTR database (110) may enable the visualization and planning of MTRs, for example, by a flight crew. The flight planning may be performed by a flight planning engine (140), and the visualization may be performed by a rendering engine. The resulting output may be provided to a user via a display (170). The user may interact with the output, and may further control the operations of the flight planning engine (140) and/or the rendering engine (150) via a user interface (160). In one or more embodiments, at least some of the shown components, for example, the flight planning engine (140), the rendering engine (150) may be hosted on a user device (190) such as a portable computing device, e.g., a tablet computer. At least part of the MTR database (110) may also be stored locally on the computing device (190), enabling a flight crew to plan and/or conduct a flight. Other aspects, such as the DAFIF processor (104) may be hosted on a server computing system. The MTR database (110) may be hosted on a networked computing system such as one or more servers that may be cloud-based. Examples of computing systems are provided below with reference to FIGS. 6A and 6B.

The DAFIF source data (102) may be downloaded from a server. The DAFIF source data (102) may be downloaded in the format of a spreadsheet, comma-separated values, etc. The DAFIF source data may be distributed over multiple downloadable files. For example, a download may include an MTR_OSM.TXT file, and MTR_OV.TXT file, an MTR_PAR.TXT file, an MTR_RMK.TXT file, and an MTR.TXT file. Content from at least some of these TXT files may be used to populate MTR database (110) with the data relied upon by the flight planning engine (140) and/or the rendering engine (150). To the extent that elements of the TXT files are used, they are described below. Broadly speaking, the MTR_OSM.TXT file may provide a description of special use airspace, the MTR_OV.TXT file may provide a description of corridors (i.e., the corridors forming the MTRs in the airspace), the MTR_PAR.TXT file may provide a parent record (providing some high-level definitions of the MTRs), the MTR_RMK.TXT file may provide remarks, and the MTR.TXT file may provide points (including geographic locations defining the location of the MTRs).

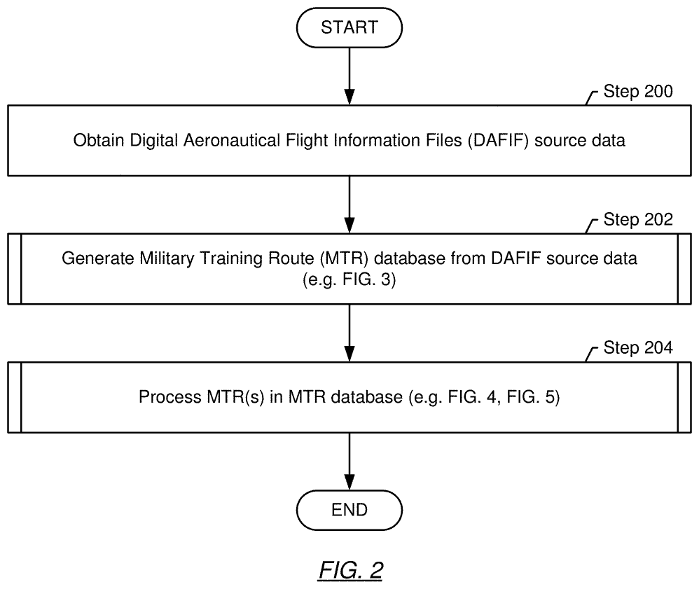

The DAFIF processor (104) includes a set of machine-readable instructions (stored on a computer-readable medium) which, when executed by a computing device, perform one or more of the operations described in the flowcharts of FIGS. 2, 3, and 4. Broadly speaking, The DAFIF processor (104) processes the DAFIF source data (102) to generate at least some of the content of the MTR database (110).

The MTR database (110) stores various data, at least some of which is obtained form the DAFIF source data (102). The different types of data stored in the MTR database (110) are subsequently discussed. In one or more embodiments, the database is accessible by multiple users. The MTR database (110) may be on a high-availability cloud-hosted content delivery network to automatically update, eliminating the need for users or user devices to manually load the data from the MTR database (110) whenever data changes.

The MTR database (110) may be implemented using any format suitable for the storage of MTR-related data, e.g., in the format of tables. The database may include, for example, text files, spreadsheets, an SQL database etc., or any other type of hierarchical, relational and/or object-oriented collection of data. In one embodiment, the MTR database (110) is SQLite based. Each data element in the MTR database (110) may be treated as a unique object with a unique key assigned to the data element. The key may serve as an identifier that allows the associated data element to be referenced, e.g., by other data elements. Consider, for example, an MTR. Many data elements may be necessary to fully characterize the MTR. For example, the MTR may include multiple points that identify geographic locations. A key may be assigned to each of the points. Further, the points may be linked to put the points into a particular order to form the MTR. A key may also be assigned to each of the links. Many other data elements may be used to characterize the MTR. For example, the route may have an identifier text, remarks text, etc. Keys may also be assigned to these elements. Finally, a key may also be assigned to the MTR itself. Accordingly, MTRs and data elements associated with the MTRs may be referenced using the associated keys. A key may be any type of identifier, for example an integer value, an alphanumeric value, etc. Each of the keys may be globally unique in the MTR database (110). In one or more embodiments of the disclosure, the MTR database (110) explicitly stores data elements not present in explicit form in the DAFIF source data (102). One such example is the links between points forming an MTR. In the DAIF source data (102), points are linked implicitly by providing a next-point for a current point. In contrast, in the MTR database (110), links are explicitly stored.

Turning to the data elements stored in the MTR database (110), the MTR table (112), in accordance with one or more embodiments, includes information providing an overall description of MTRs. For each MTR, an MTR key may be stored in the MTR database. The MTR key may serve as a unique identifier for the associated MTR. Information characterizing a route may include an MTR identifier text, an MTR remarks text, an MTR scheduling text, and MTR originating text, and MTR country code text, and/or an MTR effective time text. These elements may be directly obtained from the DAFIF source data, e.g., from one or more of the MTR files provided by the NGA. Those skilled in the art will appreciate that the data elements stored in the MTR database are those typical for characterizing MTRs, as provided by the NGA in the form of, for example, MTR files.

The MTR display point table (114), in accordance with one or more embodiments, includes points identifying geographic locations. Subsets of these points may form MTRs. The points may be obtained directly from the DAFIF source data (102), e.g., from the MTR.TXT file. An MTR display point key may be assigned to each of the points. Each point may be characterized by an MTR display point latitude, and MTR display point longitude, an MTR display point label display text, and an MTR display point usage value. The MTR display point usage value may specify an intended usage of a point on a route. A point may be used as an entry point for entering a route and/or an exit point for exiting a route, an enroute point for continuing on a route, and an alternate entry and/or exit point. The usage may be encoded by an integer value.

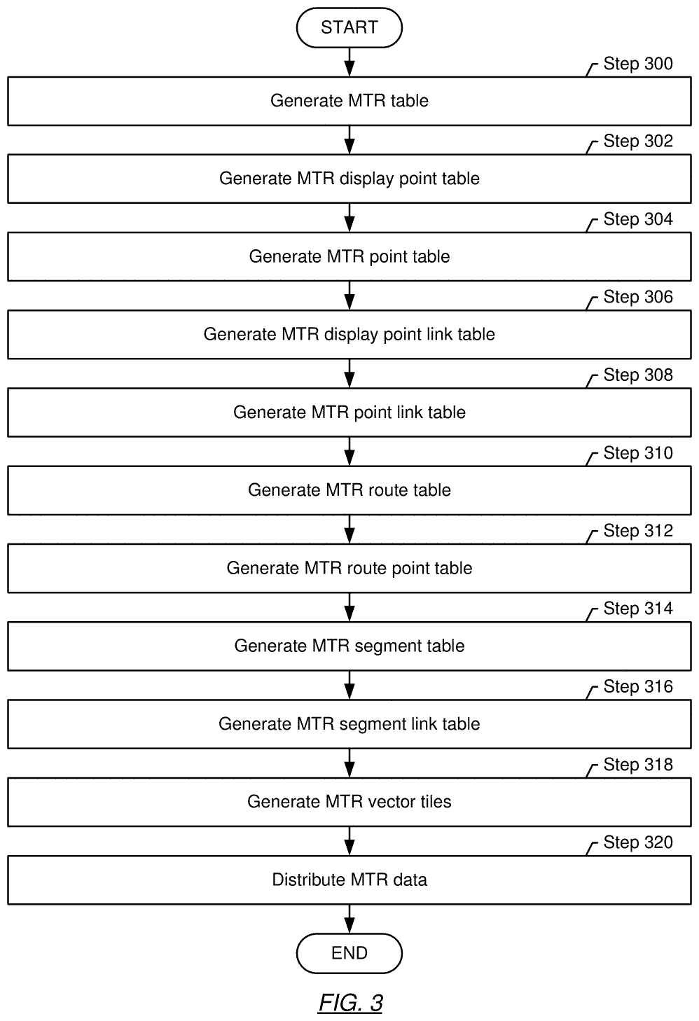

The DAFIF source data (102) may include redundant points. Points may be considered redundant if they are co-located within a certain distance. Co-located points may occur in the DAFIF source data (102) for various reasons, for example, when two routes are intersecting at a particular geographic location. In one or more embodiments, redundancies are resolved for co-located points when the MTR display point table is written. The resolution of redundancies is described in the flowchart of FIG. 3. Based on the resolution of redundancies, only a single point is written to the MTR display point table (114) when multiple co-located points are detected in the DAFIF source data (102).

In one or more embodiments, the MTR display point table (114) is relied upon for the purpose of visualizing routes, but not for routing (flight planning), as further discussed below.

The MTR point table (116), similar to the MTR display point table, in accordance with one or more embodiments, includes points identifying geographic locations. However, while the MTR display point table (114) may be used for visualizing routes, the MTR point table (116) may be used for routing. Accordingly, the entries in the MTR point table (116) are different from the entries in the MTR display point table (114) and may include additional information. An MTR point key may be assigned to each of the points defined in the MTR point table (116). Each point may be characterized by an MTR point latitude, an MTR point longitude, and MTR point ID text, MTR altitude floor binaries, an MTR floor type, an MTR floor value, MTR altitude ceiling binaries, an MTR ceiling type, an MTR ceiling value (indicating the crossing altitude, or boundaries, in feet, or indicating “surface”, or “unlimited”, whether the crossing altitude is provided “above ground level” or “mean sea level”, and whether a crossing altitude exists at all), an MTR point notes text, an MTR point usage value, an MTR associated NAVAID ID text, an MTR associated NAVAID type value, an MTR NAVAID bearing value, an MTR NAVAID distance value, an MTR point width left value, an MTR point width right value, an MTR next point width left value, and/or an MTR next point width right value. The floor, ceiling and width information may be of particular relevance to to determine a corridor associated with a route, as further discussed below. These data may be obtained directly from the DAFIF source data (102), e.g., from the MTR.TXT file.

The MTR display point link table (118), in accordance with one or more embodiments, establishes a mapping between points in the MTR display point table (114) (to be used for visualizing MTRs) and points in the MTR point table (116) (to be used for routing). An MTR display point link key may be assigned to each of the mappings defined in the MTR point table (118). Each MTR display point link may include a pair of keys consisting of an MTR display point key and an MTR point key to establish a correspondence or mapping of the points. Multiple correspondences may be established. For example, while the MTR display point table (114) does not include redundant co-located points, the MTR point table (116) may include redundant co-located points. A correspondence may be established from the single point in the MTR display point table (114) to the multiple co-located points in the MTR point table (116).

The MTR point link table (120), in accordance with one or more embodiments, establishes links between points in the MTR point table (116) (to be used for routing). An MTR point link key may be assigned to each of the links defined in the MTR point link table (120). A link may be defined by an MTR point key, and a linked MTR point key (the MTR point key and the linked MTR point key identifying points in the MTR point table (116)). In addition, a link type may be stated. The link type may state whether the MTR point key and the linked MTR point key are considered co-located or whether the linked MTR point (identified by the linked MTR point key) is considered a next-point of the MTR point (identified by the MTR point key). Whether a point is a next-point or not is not explicitly encoded in the DAFIF source data (102). More specifically, in the DAFIF source data (102), for a point, the next-point may be provided merely by the values (coordinates) of the next-point. The methods used for distinguishing next-points and co-located points are described below with reference to the flowcharts. Entire MTRs may be established through sequences of points and next-points, as further discussed below.

In one or more embodiments, the MTR route table (122), for each MTR specified in the MTR database (110), includes various basic descriptors. An MTR key may be used as an identifier for a route. Further the route type may be specified. The route type may indicate whether a route is a primary route or an alternate route. Further, a route key text may provide a descriptor (which may be the descriptor commonly used for the associated MTR, e.g., in charts).

In one or more embodiments, the MTR route point table (124), for each MTR specified in the MTR database (110), lists the points associated with the MTR. An MTR is identified by the associated MTR key. In addition, a route point key may be assigned as an identifier specific to the MTR route point table (124). For each route, a point sequence may be specified to identify the points associated with the route, in order. The points may be identified by the corresponding MTR point keys. The MTR route point table (124) may include data for primary MTRs, but not necessarily for alternate MTRs.

The MTR segment table (126), in accordance with one or more embodiments, specifies line segments (MTR segments) as the line segments may be used for visualizing routes. The specification of an MTR segment may include latitude and longitude values for beginning and end points of the MTR segment. In addition, an MTR segment key may be established as an identifier. And MTR segment label may be included as well. The MTR segment table may be built using previously identified consecutive points associated with an MTR, in sequence. Only one line segment is encoded for co-located points, in accordance with one or more embodiments.

The MTR segment link table (128), in accordance with one or more embodiments, establishes links between the segments specified in the MTR segment table. A link may be established between a first point and a second point of an MTR for MTR segments as established in the MTR segment table (126). A flag may be used to indicate whether a segment is associated with a primary MTR or an alternate MTR.

The MTR vector tiles (130), in accordance with one or more embodiments, are delimited regions, e.g., squares or rectangles representing a geographic region for which vectors to be used for visually rendering the routes are pre-computed. An MTR vector tile may overlap with one or more routes and/or route segments. An MTR vector tile may, thus, include vector representations of all (or at least some) of the MTRs traversing the MTR vector tile. The vector representations may be computed from the MTR representations in the MTR database (110), in particular, using the MTR segment table (126) and the MTR segment link table (128).

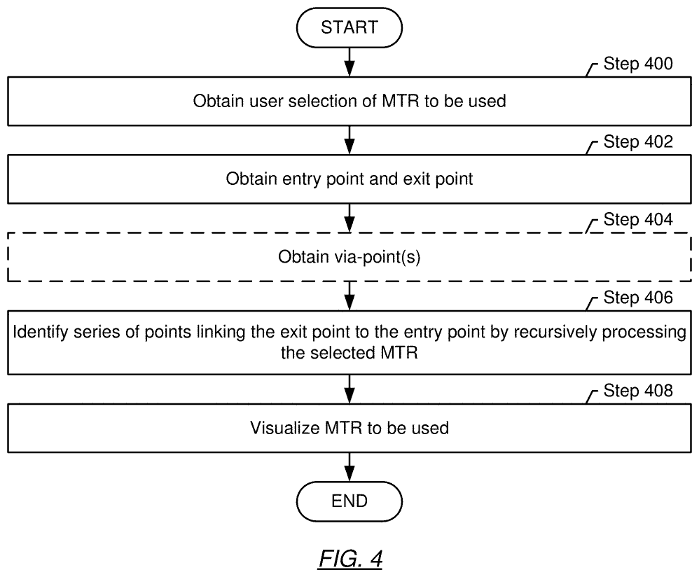

Turning to the components that may rely on the content stored in the MTR database (110), the flight planning engine (140), in accordance with one or more embodiments, provides functionality enabling users (e.g., a flight crew) to plan and or conduct a flight including MTRs. The flight planning engine (140) may include software instructions that enable a user to compose, edit and view a flight plan. The flight planning engine (140) may include software instructions that compute an estimate of the duration of a flight and/or that estimate fuel consumption based on various considerations that may include weather, flight restrictions, airspace congestion, etc. The flight planning engine may be configured to superimpose a flight path from a departure point to an arrival point, on a map to be displayed to the user. In one or more embodiments, the selected flight path may include an MTR. The flight planning engine (140) may include a set of machine-readable instructions (stored on a computer-readable medium) which, when executed by a computing device (e.g., a computing device as described below with reference to FIGS. 6A and 6B), perform one or more of the operations described in the flowcharts of FIG. 4.

The flight planning engine (140) may interface with or may be part of an integrated flight application. The integrated flight application may include various components that may serve an aircraft crew, e.g., pilots, co-pilots, etc. These components may include, for example, various types of maps (visual flight rules (VFR) sectionals, VFR and instrument flight rules (IFR) en-route charts, airport diagrams, terminal area charts, world aeronautical charts, surface maps showing terrain features, streets, weather charts, etc.). The maps may be set up as layers and/or overlays that give the flight crew the flexibility to review the most relevant or desired features, while hiding currently non-relevant features in a situation-specific manner. For example, based on an initial zoom level used to show a larger geographic area, only an airport symbol may be shown, and upon zooming in, airport diagrams, complete with runways, taxi labels, and fixed-based operator (FBO) locations may appear.

The integrated flight application may be used to gather and view information during a flight, but also to plan flights and/or to select routes based on flight plans. The selected routes may then be displayed on maps. Maps provided by the integrated flight application may be moving maps for air and/or ground operations that include an own-ship display indicting the current position of the aircraft on the moving map as the flight is progressing.

A rendering engine (150) may be used to prepare visual content on a display (170). The rendering engine (150) may process visual content provided by the flight planning engine (140), including maps, artificial horizons, obstructions, etc. The rendering engine (150) may further process visual content obtained from the flight planning engine (140). For example, the rendering engine may be used to visualize a flight plan, the MTRs that are part of the flight plan prior to conducting the flight, e.g., when planning the flight, and/or in-flight. The MTR data to be used by the rendering engine may be based on the MTR vector tiles (130). MTRs represented in the MTR vector tiles may be directly rendered and/or may be superimposed on a map for visualizations that show other content (such as terrain features, airspace, airport layouts, etc.), in addition to the MTRs.

The rendering engine (150) may further provide other functionalities such as font and symbol scaling in a zoom-level dependent manner, adjustment of the transparency of overlays to ensure readability and/or the use of different visualization schemes (color/brightness) depending on whether daytime or nighttime conditions are detected. The rendering engine (150) may be hardware and/or software configured to generate the visual content to be displayed.

The display (170) may be a screen, such as a liquid crystal display (LCD), light emitting diode (LED) or organic LED (OLED) screen or any other type of display that supports visual content to be shown to a user, including MTRs, various layers of maps, additional symbolic or text content, etc. Specialized display technologies or accessories may further be used, e.g., displays that are customized for nighttime use.

The user interface (160) may enable a user to provide input to control the visualization of content by the rendering engine (150) and the processing of MTRs by the flight planning engine (140). For example, the user interface (160) may enable zooming and panning to alter rendered images prepared by the rendering engine (150). Other changes, such as changes in color coding, the activation or deactivation of layers, etc., may be controlled via the user interface (160) without departing from the disclosure. The user interface may further enable the user to provide any input affecting the operation of the flight planning engine (140). For example, the user interface may accept input for selecting an entry point and/or exit point for using an MTR. The user interface may further accept a selection of a primary or an alternate MTR. Any input that may be useful or necessary for the execution of the methods described in FIGS. 2, 3, and 4 may be accepted by the user interface. The user interface (160) may be any type of input interface such as a touch screen interface, a keyboard, a mouse, a touchpad, a spoken language user interface, etc.

While FIG. 1 shows a configuration of components, other configurations may be used without departing from the scope of the disclosure. For example, various components may be combined to create a single component. As another example, the functionality performed by a single component may be performed by two or more components. In particular, FIG. 1 shows one particular arrangement of MTR data in an MTR database, generated from DAFIF source data. The MTR data may be organized in different manners, suitable for flight planning and visualizing MTRs, without departing from the disclosure. Further, while in FIG. 1, the MTR data is provided in DAFIF format, the MTR data may be provided in any other format. To accommodate other formats, the DAFIF processor may be replaced by another processor. Accordingly, the disclosed embodiments should not be considered limited to the specific arrangements of components and/or elements shown in FIG. 1.

FIGS. 2, 3, and 4 show flowcharts in accordance with one or more embodiments of the disclosure. While the various steps in these flowcharts are presented and described sequentially, one of ordinary skill will appreciate that some or all of these steps may be executed in different orders, may be combined or omitted, and some or all of the steps may be executed in parallel. In one embodiment of the disclosure, the steps shown in FIGS. 3 and 4 may be performed in parallel with any other steps shown in FIGS. 3 and 4, without departing from the disclosure.

FIG. 2 describes a method for processing MTRs, in accordance with one or more embodiments of the disclosure. FIG. 2 may be understood as a summary figure, whereas subsequently described FIGS. 3 and 4 provide additional details.

In Step 200, digital aeronautical flight information files (DAFIF) source data is obtained. The DAFIF source data may be downloaded whenever an updated version becomes available. The download may be scheduled or alternatively the download may be manually performed. The DAFIF source data may be downloaded as TXT files, or in any other available format.

In Step 202, the MTR database is established using the DAFIF source data. Step 202 may be executed as soon as new DAFIF source data has been downloaded. As further described in detail below, the execution of Step 202 may result in the generation of various tables. These tables may represent the DAFIF source data in a format suitable for flight planning and for visualizing routes. Some data elements may be directly obtained from the DAFIF source data, whereas other data elements may be obtained indirectly through additional processing. Accordingly, the DAFIF source data is processed in a manner to obtain an explicit representation of data that would otherwise not be directly available. For example, links between points are not explicitly available in the DAFIF source data. Tables with links are, thus, generated by processing the DAFIF source data as discussed in detail below. Step 202 may be periodically performed offline. In other words, Step 202 is typically not performed at the time when a user performs flight planning or visualizes a route, but whenever new DAFIF source data becomes available. Step 202 may be executed as described in FIG. 3.

In Step 204, one or more MTRs in the MTR database are processed. Step 204 may be executed upon user request. More specifically, Step 204 may be performed when a user performs route planning involving one or more MTRs or when the user visualizes MTRs. Step 204 may be executed as described in FIG. 4.

FIG. 3 describes a method for generating the MTR database, in accordance with one or more embodiments.

In Step 300, the MTR table is generated. The MTR identifier text, the MTR remarks text, the MTR scheduling text, the MTR originating text, the MTR country code text, the MTR effective time text, and/or other information to be included in the MTR table may be directly obtained from the DAFIF source data. The globally unique MTR key may be assigned either randomly or systematically.

In Step 302, the MTR display point table is generated. The points, including the associated MTR display point latitudes, MTR display point longitudes, MTR display point label display texts, and MTR display point usage values, and/or other information to be included in the MTR display point table may be directly obtained from the DAFIF source data. The globally unique MTR display point keys for the points may be assigned either randomly or systematically. In one or more embodiments, redundant points that may exist in the DAFIF source data are removed. A “close enough” check is performed to determine whether two points are redundant. For example, if two points are located within 0.0000011 decimal degrees, they may be considered redundant. Close enough is determined by comparison with a threshold. In this case, a redundancy resolution may be performed by prioritizing points in a particular order: A points that serves as an entry and exit point may have the highest priority, followed by a point that serves as an entry or exit point. If one point serves as an exit point and another co-located point serves as an entry point, the two points may be replaced by a single point that serves as an entry and exit point. Alternate entry and exits points may follow. If one point serves as an alternate exit point and another co-located point serves as an alternate entry point, the two points may be replaced by a single point that serves as an alternate entry and exit point. An enroute point may have the lowest priority. Based on these rules, a single point may be selected whenever multiple co-located points are found.

In Step 304, the MTR point table is generated. The points, including the associated MTR point latitudes, MTR point longitudes, MTR point ID texts, MTR altitude floor binaries, MTR floor types, MTR floor values, MTR altitude ceiling binaries, MTR ceiling types, MTR ceiling values, MTR point notes texts, MTR point usage values, MTR associated NAVAID ID texts, MTR associated NAVAID type values, MTR NAVAID bearing values, MTR NAVAID distance values, MTR point width left values, MTR point width right values, MTR next point width left values, MTR next point width right values, and/or other information to be included in the MTR point table may be directly obtained from the DAFIF source data.

The globally unique MTR point keys for the points may be assigned either randomly or systematically.

In Step 306, the MTR display point link table is generated. The mappings between points in the MTR display point table (generated in Step 302) and points in the MTR point table (generated in Step 304) are established using pairs of keys consisting of an MTR display point key and an MTR point key to establish a correspondence or mapping of the points. Multiple correspondences may be established. For example, while the MTR display point table does not include redundant co-located points, the MTR point table may include redundant co-located points. A mapping may be established between the single point in the MTR display point table and the multiple co-located points in the MTR point table. The mappings may be generated either while the MTR display point table and the MTR point table are simultaneously generated, or alternatively after the creation of the MTR display point table and the MTR point table, based on the coordinates of the points (e.g., latitude and longitude). The globally unique MTR display point link keys for the mappings may be assigned either randomly or systematically.

In Step 308, the MTR point link table is generated. The links between the points in the MTR point table (generated in Step 304). A link may be defined by an MTR point key, and a linked MTR point key (the MTR point key and the linked MTR point key identifying points in the MTR point table). No links are explicitly stored in the DAFIF source data. However, in the DAFIF source data, the definition of a point typically includes the definition of a next-point. Links may, thus, be generated by analyzing next-point data of points.

The link type may also not be explicitly stored in the DAFIF source data. A proximity logic may be used to determine whether a point and a next-point are at the same location. If so, the link type indicates that these are the same points. If not, the next-point is actually considered a proper next-point. The globally unique MTR point link keys for the links may be assigned either randomly or systematically.

In Step 310, the MTR route table is generated. The route type and the route key text may be directly obtained from the DAFIF source data.

In Step 312, the MTR route point table is generated. The list of points for each of the MTRs specified in the MTR database may be generated directly based on the DAFIF source data.

In Step 314, the MTR segment table is generated. The latitude and longitude values for beginning and end points of the MTR segments may be directly obtained from the DAFIF source data. The globally unique MTR segment keys may be assigned either randomly or systematically.

In Step 316, the MTR segment link table is generated. The first points and second point and the distinction between primary and alternate route of an MTR segment may be obtained based on already prepared MTR tables such as the MTR segment table and the MTR display point table.

In Step 318, the MTR vector tiles are generated. The vector tiles may be generated by processing the entries in the MTR segment link table and the MTR segment table. MTR segments that are found to overlap with an MTR vector tile are included in the MTR vector tile. Prior to generating the MTR vector tiles, the points and lines to be included in the MTR vector tiles may be represented in GeoJSON, a subtype of JSON for geospatial representations. Tippecanoe (a tool provided by MapBox) may be used for the vector tiles.

In Step 320, the MTR data is distributed to user devices. The MTR database may be hosted on a high-availability cloud-hosted content delivery network to automatically update the user devices.

Steps 300 to 320 may be modified for implementations that use data sources different from DAFIF, without departing from the disclosure. Further, additional optimizations such as indexing of the data entries in the tables may be performed.

FIG. 4 describes a method for processing the MTRs in the MTR database, in accordance with one or more embodiments.

In Step 400, a user selection of the MTR that the user intends to use is obtained. The selected MTR is one of the MTRs in the MTR database. The user may, for example, enter an MTR identifier based on which the selected MTR is located using the MTR table. Alternatively, the user may select the MTR by clicking on the MTR in a display of, for example, a map that shows MTRs.

In Step 402, an entry point and an exit point are obtained, in accordance with one or more embodiments. The entry point may be provided by a user selecting a point of an MTR as an entry point. The user may enter an alphanumeric identifier to select a point, or may graphically select the entry point by clicking on a point. The selected point may be identified based on the points in the MTR point table. Alternatively, if the user does not provide an entry point, the primary entry point of the MTR may be selected by default. The exit point may be selected in a similar manner.

In Step 404, one or more via-points may be obtained from the user in a manner similar to the selection of entry and exit points. Via-points are optional. The user may choose to specify a via-point to ensure that the series of points linking the exit point to the entry point, as determined in Step 406, traverses the via-point. Adaptive routing that is automatic, yet providing the user with some control over the points to be used is thus available.

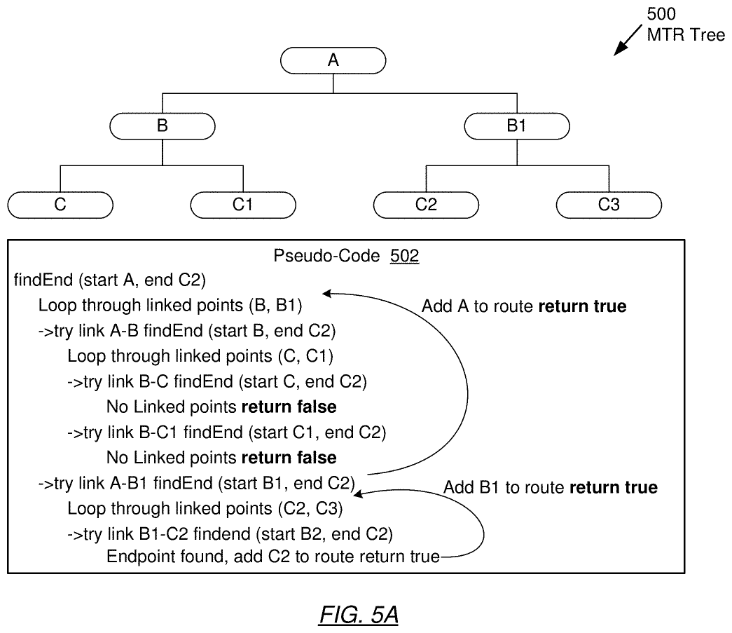

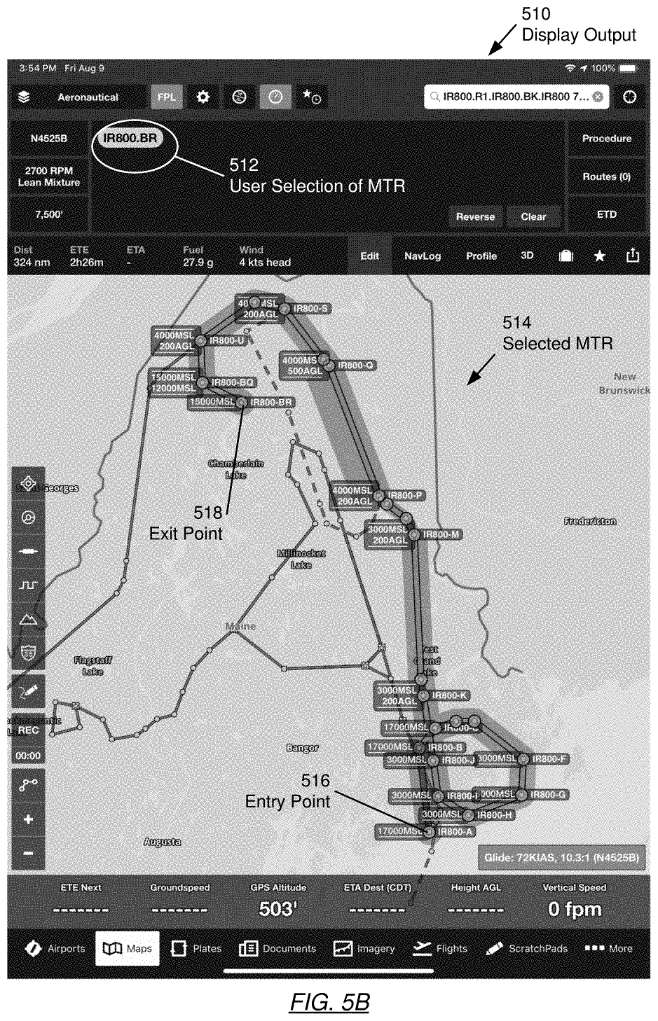

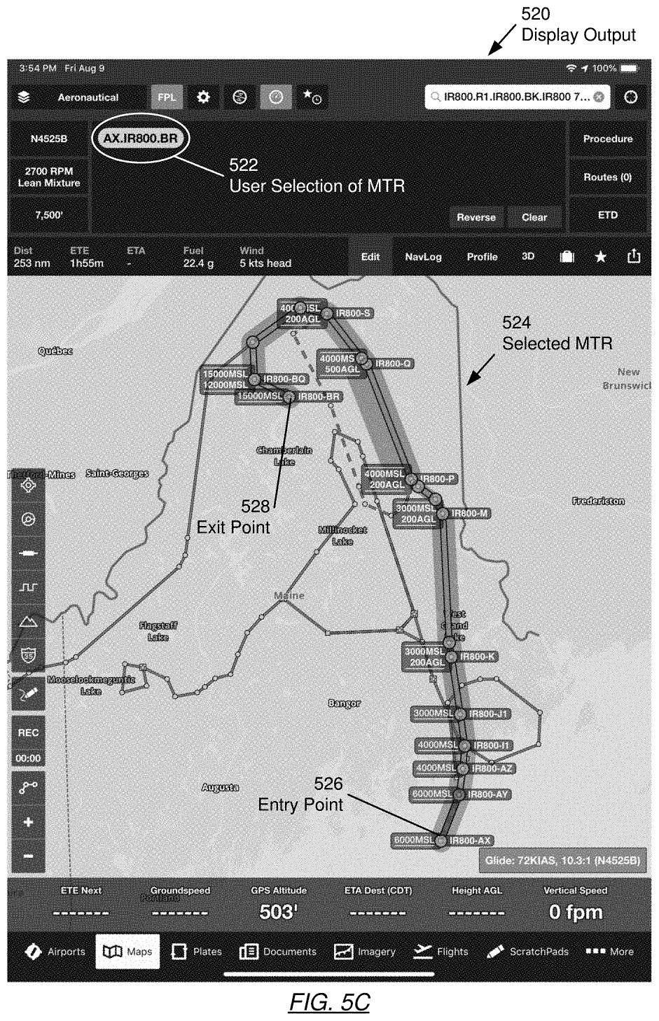

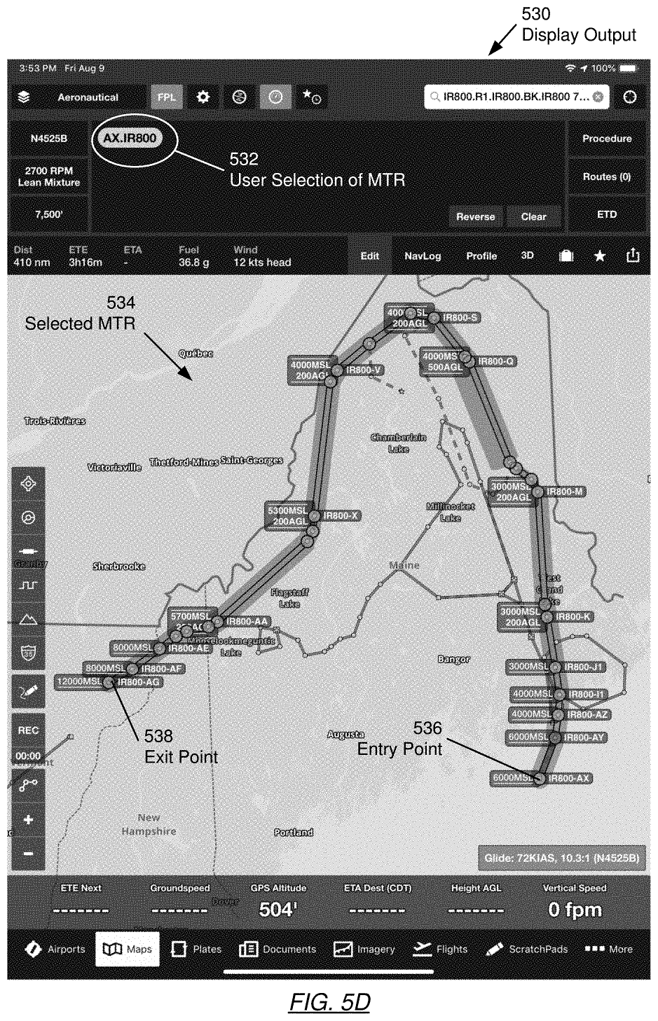

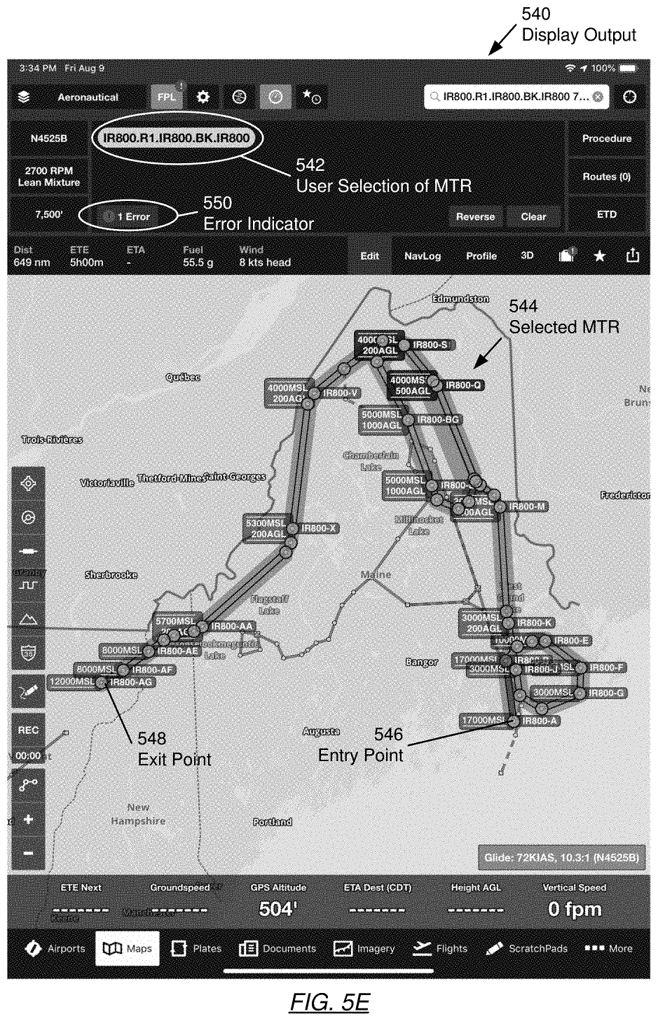

In Step 406, a series of points linking the exit point to the entry point by recursively processing the selected MTR is identified. The identification may be performed recursively. Assuming that the MTR that is being processed includes multiple branches formed by series of linked points associated with the MTR, an initially selected branch of the MTR may be followed for as long as possible, starting from the entry point, to reach the exit point. If the exit point is not reached, the recursive algorithm may attempt to proceed on a different branch of the MTR. Primary MTRs may be prioritized over alternate MTRs. The recursive processing of MTRs may be continued until a series of points that reaches the exit point is identified. If one or more via-points have been specified by the user, the series of points necessarily includes the via-point(s). The recursive processing may rely on data from the MTR point table, the MTR point link table, the MTR route table, and the MTR route point table. In particular, an MTR may be followed based on the links that have been established in the MTR database as previously discussed. More specifically, each MTR may be represented by a series of consecutive links that may be followed to move from point to point, along the MTR. Because the links are unidirectional, improper routing in a “backward” direction may be avoided. Further, to avoid infinite loops, a sequence of points may be limited to a maximum number of points, for example, 100 points. The recursive processing algorithm may internally keep track of the level of recursion, counts of how many other points a point connects to on the MTR, and other variables, to facilitate troubleshooting. An example further illustrating the recursive processing is provided below in FIG. 5A.

In Step 404, the MTR to be used is visualized. The visualization, in one or more embodiments, shows a corridor of the MTR to be used, enabling the user to see the full room available to maneuver, including upper and lower altitude limits across the route. To draw the corridor, a point, a next-point and a previous-point may be analyzed for any given MTR point to calculate corner angle. If a turn exists at an MTR point, based on the corner angle, the inside edge of the turn may be “mitred,” to form a sharp corner, and the outside edge of the turn may be rounded.

MTR corridors from point to point may be generally constant width. However, in specific cases an MTR corridor may taper from point to point. In one or more embodiments, in Step 404, the remarks in the MTR table are scanned for keywords that indicate tapering. A string-matching may be performed to detect the keywords which may include “taper”, “expand”, etc. When, based on the remarks, a tapering is detected, the tapering may be visualized using the MTR point width left value, the MTR point width right value, the MTR next point width left value, and/or the MTR next point width right value.

In one or more embodiments, the visualized MTR, e.g. a corridor is visually superimposed on a map (which may be provided in a raster image data format) and/or may be shown in a glass flight display system.

Terrain, obstructions, intersections, potentially overlapping corridors of other MTRs, maneuvering areas, warnings, and/or other contextual information may be shown to improve the situational awareness. The data for visualizing these elements may be obtained from other databases. In-flight real-time warnings may be provided when a possible imminent collision with an obstruction is detected based on the current position, heading, and speed of the aircraft.

In one or more embodiments, the MTR to be used (obtained in Step 402), may be further processed. Specifically, the MTR may be processed by a flight planning engine to determine fuel burn and flight time under consideration of forecast winds, altitudes to avoid obstructions, etc. As a result, a full-featured flight plan through the MTR to be used may be obtained, including magnetic headings, leg lengths, a fuel plan, etc. The obtained flight plan may be placed into a NavLog and flight plan filing system to complete the flight planning process.

Turning to FIG. 5XXX, various examples illustrating the operation and output of the methods for processing MTRs are shown.

FIG. 5A illustrates the recursive processing of an MTR based on an example of an MTR. The MTR consists of the points A, B, C, C1, B1, C2, and C3 visualized as an MTR tree (500). Assume that the user specifies point A as the entry point, and point C2 as the exit point. The recursive processing is performed by a function “findEnd”, as shown by the pseudo-code (502) in FIG. 5A. Initially, the branch including the points A, B, and C is examined without finding the specified exit point, C2. Next, the branch including the points, A, B, and C1 is examined, again without finding the specified exit point. Finally, when examining the branch A, B 1, C2, the exit point is found. The probing of the branches is conducted recursively, as illustrated by the pseudo-code.

FIG. 5B shows a visualization of an MTR, after the recursive processing of the MTR. The display output (510) may be of an electronic flight bag application and may display a map and may provide access to other functionalities. The display output (510) includes a user interface for a user selection of an MTR (512). The user selection, in this scenario is the MTR “IR800”. No entry point is specified. An exit point “BR” is specified. The selected MTR (514) is visualized, including the linked points between the entry point (516) and the exit point (518). Because no entry point is specified by the user, the primary entry point is used. The visualization includes a corridor whose definition includes floor and ceiling values.

FIG. 5C shows a visualization of an MTR, after the recursive processing of the MTR in a display output (520). The display output (520) includes a user interface for a user selection of an MTR (522). The user selection, in this scenario is the MTR “IR800”. An entry point “AX” is specified, and an exit point “BR” is specified. The selected MTR (534) is visualized, including the linked points between the entry point (526) and the exit point (528). Because the entry point (526) is different from the default entry point, the visualized linked points in FIG. 5C are different from the visualized linked points in FIG. 5B. The visualization includes a corridor, including floor and ceiling values.

FIG. 5D shows a visualization of an MTR, after the recursive processing of the MTR in a display output (530). The display output (530) includes a user interface for a user selection of an MTR (532). The user selection, in this scenario is the MTR “IR800”. An entry point “AX” is specified, but no exit point is specified. The selected MTR (534) is visualized, including the linked points between the entry point (536) and the exit point (538). Because the exit point (536) is not specified, the MTR uses the primary exit point. The visualization includes a corridor, including floor and ceiling values.

FIG. 5E shows a visualization of an MTR, after a recursive processing of the MTR in a display output (540). The display output (540) includes a user interface for a user selection of an MTR (542). The user selection, in this scenario is the MTR “IR800”. No entry point and no exit point are specified. Via-points R1 and BK are specified. The selected MTR (544) is visualized, including the linked points between the entry point (546) and the exit point (548). Because no entry point and no exit point are specified by the user, the primary entry point and the primary exit point is used. The visualization includes a corridor whose definition includes floor and ceiling values. Additional via-points of this MTR may be specified in a similar manner. Further, additional different MTRs may also be specified. These MTRs may then be chained together. The display output (540) further includes an error indicator (550). The error indicator may be for various reasons. In the example as shown, the error indicator is a result of insufficient fuel for completion of the MTR, detected during the flight planning.

Various embodiments of the disclosure may have one or more of the following advantages. Embodiments of the disclosure enable a user to plan and conduct a flight using MTRs. Embodiments of the disclosure process available MTRs to develop a flight plan that includes using one or more of the MTRs from an entry point to an exit point. Subsequently, the corridor of the MTR to be used may be displayed including advanced MTR features such as tapering. The corridor may be visualized in context, including the full area through which one may maneuver on the MTR, including terrain, obstacles, etc. The primary MTR, alternate MTRs, maneuvering areas, overlapping other MTRs and other features may be displayed.

Embodiments of the invention facilitate the use of MTRs by automating the intake of updated DAFIF source data, which may then be available for use in conjunction with other flight planning data. Accordingly, any changes, such as the addition/decommissioning of an MTR, magnetic headings, available navaids, etc., may be dealt with in an effortless, efficient manner. The significant manual processing associated with the conventional use of DAFIF data is reduced or eliminated.

Embodiments of the invention are portable and may be used on a user device such as a tablet computer.

Embodiments of the disclosure may be implemented on a computing system. Any combination of mobile, desktop, server, router, switch, embedded device, or other types of hardware may be used. For example, as shown in FIG. 6.A, the computing system (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), and numerous other elements and functionalities.

The computer processor(s) (602) may be an integrated circuit for processing instructions. For example, the computer processor(s) may be one or more cores or micro-cores of a processor. The computing system (600) may also include one or more input devices (610), such as a touchscreen, keyboard, mouse, microphone, touchpad, electronic pen, or any other type of input device.

The communication interface (612) may include an integrated circuit for connecting the computing system (600) to a network (not shown) (e.g., a local area network (LAN), a wide area network (WAN) such as the Internet, mobile network, or any other type of network) and/or to another device, such as another computing device.

Further, the computing system (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (600) in FIG. 6A may be connected to or be a part of a network. For example, as shown in FIG. 6B, the network (620) may include multiple nodes (e.g., node X (622), node Y (624)). Each node may correspond to a computing system, such as the computing system shown in FIG. 6A, or a group of nodes combined may correspond to the computing system shown in FIG. 6A. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (600) may be located at a remote location and connected to the other elements over a network.

Although not shown in FIG. 6B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (622), node Y (624)) in the network (620) may be configured to provide services for a client device (626). For example, the nodes may be part of a cloud computing system. The nodes may include functionality to receive requests from the client device (626) and transmit responses to the client device (626). The client device (626) may be a computing system, such as the computing system shown in FIG. 6A. Further, the client device (626) may include and/or perform all or a portion of one or more embodiments of the disclosure.

The computing system or group of computing systems described in FIGS. 6A and 6B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system in FIG. 6A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query provided to a structured data repository (where the data repository may be organized according to a database schema or data format, such as XML).

The extracted data may be used for further processing by the computing system. For example, the computing system of FIG. 6A, while performing one or more embodiments of the disclosure, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 6A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 6A may include functionality to provide raw and/or processed data, such as results of comparisons and other processing. For example, providing data may be accomplished through various presenting methods. Specifically, data may be provided through a user interface provided by a computing device. The user interface may include a GUI that displays information on a display device, such as a computer monitor or a touchscreen on a handheld computer device. The GUI may include various GUI widgets that organize what data is shown as well as how data is provided to a user. Furthermore, the GUI may provide data directly to the user, e.g., data provided as actual data values through text, or rendered by the computing device into a visual representation of the data, such as through visualizing a data model.

For example, a GUI may first obtain a notification from a software application requesting that a particular data object be provided within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be provided through various audio methods. In particular, data may be rendered into an audio format and provided as sound through one or more speakers operably connected to a computing device.

Data may also be provided to a user through haptic methods. For example, haptic methods may include vibrations or other physical signals generated by the computing system. For example, data may be provided to a user using a vibration generated by a handheld computer device with a predefined duration and intensity of the vibration to communicate the data.

The above description of functions presents only a few examples of functions performed by the computing system of FIG. 6A and the nodes and/or client device in FIG. 6B. Other functions may be performed using one or more embodiments of the disclosure.

While the disclosed technology has been described with respect to a limited number of embodiments, those skilled in the art, having benefit of this disclosed technology, will appreciate that other embodiments can be devised which do not depart from the scope of the disclosed technology as disclosed herein. Accordingly, the scope of the disclosed technology should be limited only by the attached claims.

What is claimed is:

1. A method for processing military training routes (MTRs), the method comprising:
obtaining an MTR database comprising, for a plurality of MTRs:
a plurality of points for each of the plurality of MTRs, and
a plurality of links between the plurality of points;
obtaining a user input comprising a selection of an MTR of the plurality of MTRs;
recursively processing the selected MTR by following the plurality of links between the plurality of points associated with the selected MTR until a sequence of consecutive points of the plurality of points between an entry point and an exit point is found; and
visualizing the selected MTR.

2. The method of claim 1, further comprising, prior to obtaining the MTR database:
generating the MTR database by:
obtaining source data representing the plurality of MTRs, and
processing the source data to generate an explicit representation of the plurality of points and the plurality of links between the plurality of points of each of the plurality of MTRs for routing; and
sharing the MTR database with a plurality of user devices.

3. The method of claim 2, wherein the source data comprises Digital Aeronautical Flight Information Files (DAFIF).

4. The method of claim 2, wherein processing the source data comprises removing redundant points.

5. The method of claim 4, wherein, for the removal of the redundant points, the redundant points are prioritized in the order of:
(1) serving as entry and exit,
(2) serving as entry or exit,
(3) serving as alternate entry or exit, and
(4) serving as enroute point.

6. The method of claim 2,
wherein generating the MTR database is periodically performed offline; and
wherein recursively processing the selected MTR is performed upon user request.

7. The method of claim 1, wherein following the plurality of links between the plurality of points associated with the selected MTR until the sequence of consecutive points of the plurality of points between the entry point and the exit point is found comprises:
from the entry point, following a first branch of the selected MTR, represented by a first subset of the plurality of links between the plurality of points associated with the selected MTR, as long as possible;
determining that the first branch does not reach the exit point; and
switching to a second branch of the selected MTR, represented by a second subset of the plurality of links between the plurality of points associated with the selected MTR, to reach the exit point.

8. The method of claim 7, wherein following the plurality of links between the plurality of points associated with the selected MTR until the sequence of consecutive points of the plurality of points between the entry point and the exit point is found further comprises selecting one of the first branch and the second branch to include a user-specified via-point.

9. The method of claim 1, wherein recursively processing the selected MTR further comprises prioritizing primary MTRs over alternate MTRs.

10. The method of claim 1, wherein visualizing the selected MTR comprises visualizing a corridor along the sequence of consecutive points, wherein the corridor is defined by at least a floor, a ceiling, and a width.

11. The method of claim 10, wherein visualizing the selected MTR comprises:
detecting that the selected MTR comprises tapering based on a remarks text; and
visualizing a segment of the corridor at which the corridor tapers based on the remarks text.

12. The method of claim 10, wherein the corridor is superimposed on a background providing contextual information.

13. The method of claim 12, wherein the background providing the contextual information comprises at least one selected from terrain, structures, obstructions, and hazard warnings.

14. The method of claim 1, wherein the entry point is one selected from:
a user-specified entry point, and
a default entry point.

15. The method of claim 1, further comprising:
preparing a flight plan based on the selected MTR.

16. The method of claim 15, wherein preparing the flight plan comprises determining fuel consumption.

17. A system for processing military training routes (MTRs), the system comprising:
a first computer processor; and
first instructions executing on the first computer processor, causing the system to:
obtain an MTR database comprising, for a plurality of MTRs:
a plurality of points for each of the plurality of MTRs, and
a plurality of links between the plurality of points;
obtain a user input comprising a selection of an MTR of the plurality of MTRs;
recursively process the selected MTR by following the plurality of links between the plurality of points associated with the selected MTR until a sequence of consecutive points of the plurality of points between an entry point and an exit point is found; and
visualize the selected MTR.

18. The system of claim 17, further comprising:
a second computer processor; and
second instructions executing on the second computer processor, causing the system to, prior to obtaining the MTR database:
generate the MTR database by:
obtaining source data representing the plurality of MTRs, and
processing the source data to generate an explicit representation of the plurality of points and the plurality of links between the plurality of points of each of the plurality of MTRs for routing; and
sharing the MTR database with a user devices comprising the first computer processor.

19. A non-transitory computer readable medium comprising computer readable program code for causing a computer system to:
obtain an MTR database comprising, for a plurality of MTRs:
a plurality of points for each of the plurality of MTRs, and
a plurality of links between the plurality of points;
obtain a user input comprising a selection of an MTR of the plurality of MTRs;
recursively process the selected MTR by following the plurality of links between the plurality of points associated with the selected MTR until a sequence of consecutive points of the plurality of points between an entry point and an exit point is found; and
visualize the selected MTR.

20. The non-transitory computer readable medium of claim 19, wherein the computer readable program code further causes the computer system to generate the MTR database by:
obtaining source data representing the plurality of MTRs, and
processing the source data to generate an explicit representation of the plurality of points and the plurality of links between the plurality of points of each of the plurality of MTRs for routing; and
sharing the MTR database with a plurality of user devices.
